(19) United States
(12) Patent Application Publication
(10) Pub. No.: US 2004/0167954 A1
(43) Pub. Date: Aug. 26, 2004

(54) Overflow detection system for multiplication

(75) Inventor: Alexander Griessing, Sunnyvale, CA (US)

Correspondence Address: STAAS & HALSEY LLP, SUITE 700, 1201 NEW YORK AVENUE, N.W., WASHINGTON, DC, 20005, US

(73) Assignee: INFINEON TECHNOLOGIES NORTH AMERICA CORP., San Jose, CA

(21) Appl. No.: 10/370,054

(22) Filed: Feb. 21, 2003

(51) Int. Cl. G06F 7/38

(52) U.S. Cl. 708/552

(57) ABSTRACT

A math device has a multiplier and an overflow detector. The multiplier multiplies an n-bit input with an m-bit input and produces a reduced width output without producing an intervening data file having a width greater than or equal to n+m. The overflow detector determines if the reduced width output eliminates non-redundant bits. According to a second aspect, the overflow detector determines when the product of the m-bit input and the n-bit input would exceed o-bits, where o<(m+n), the overflow detector having a first overflow unit provided in parallel to the multiplier, and a second overflow unit provided in series with the multiplier. According to a third aspect, the overflow detector has a comparator provided on a critical timing path, and the comparator requires only a review of 4 bits.

### BACKGROUND OF THE INVENTION

A CPU contains circuitry to perform multiplication of two signed or unsigned integer numbers. Both input values, called A and B, are represented as binary vectors of a certain width, e.g. A is 32 bit wide, B is 32 bit wide. Multiplying these two vectors yields a product vector, called Y. The maximum width of the resulting product vector Y is the sum of the widths of the two input vectors. For example, the maximum width of Y is 64 bit.

Often the product vector is required to be of the same width as the input vectors. For example, the product vector may need to be stored in the same register file as the input vectors, or may need to serve as an input vector itself the next time multiplication is performed. Therefore the full-width product vector Y must be transformed into a reduced-width vector, called Y1. A commonly used method to reduce the width of the product vector is saturation.

Saturation is a two-step process. First, overflow detection is performed in which it is determined whether the product vector Y exceeds the upper or lower limit of representable numbers in the reduced width of Y1. The upper limit for Y1 is the biggest representable positive number. The lower limit for Y1 is zero in case of unsigned numbers, or the most negative number in case of signed numbers. Second, if overflow is detected, then Y1 is set equal to the upper or lower limit, whichever has been exceeded. If there is no overflow, then the higher-order bits of Y are redundant, and are simply cut-off.

Saturation, including the necessary overflow detection process, is complex and can add considerable delay to the timing critical path.

In another typical application, multiplication is immediately followed by accumulation, which means that the full-width product vector Y is added to or subtracted from a third input vector, called C. This input vector C can have the same width as the other two input vectors A and B, in our example 32 bit. The accumulation result, called Z, has a maximum width, which is 1 bit bigger than that of the product vector Y. Thus, the maximum width of Z in our example is 65 bit. As with the product vector Y, the vector Z is often required to be transformed into a reduced-width result Z1, which has the same width as the inputs A, B and C. Thus, the reduced-width Z1 is 32 bit wide in our example. As before, saturation can be used to accomplish this width reduction.

FIG. 1A is a schematic view of a multiplier of the related art, which employs saturation. In FIG. 1A, input vectors A and B are multiplied to produce a product vector Y. Product vector Y may be twice as wide as the input vectors. After multiplication, overflow detection is performed to determine whether the product vector Y must be saturated. The overflow result controls a multiplexer to select the final reduced-width result Y1 among the product vector Y with its redundant high-order bits being cut-off, and, for the overflow case, a pre-determined saturation value.

FIG. 1B is a schematic view of a multiplier with accumulation of the related art, which employs saturation. In FIG. 1B, input vectors A and B are multiplied to produce a product vector Y. Product vector Y may be twice as wide as the input vectors. Product vector Y is then accumulated to an input vector C, producing a result vector Z that is potentially 1 bit wider than the product vector Y. After these processes, overflow detection is performed to determine whether the result vector Z must be saturated. The overflow result controls a multiplexer to select the final reduced-width result Z1 among the result vector Z with its redundant high-order bits being cut-off, and, for the overflow case, a pre-determined saturation value.

In FIG. 1A, product vector Y is 64 bit wide, and in FIG. 1B, result vector Z is 65 bit wide. From FIGS. 1A and 1B, it should be apparent that it is necessary to develop the complete full-width multiplication and accumulation results Y and Z, even though many of the result bits will eventually not contribute directly to the final results Y1 and Z1. The full-width results are necessary to accurately perform overflow detection.

For unsigned operation, the 33^{rd} and all higher bits must contain redundant ‘0’ to not cause overflow. Therefore, overflow detection is performed by searching the 33^{rd} and all higher bits for any occurrence of a ‘1’. The commands on the left below apply to FIG. 1A, and those on the right below apply to FIG. 1B.

if (Y[63:32] !=32′b 0) if (Z[64:32] !=33′b 0)

OVF=1; OVF=1;

else else

OVF=0; OVF=0;

For signed operations, the 32^{nd} and all higher bits must contain identical, redundant sign bits to not cause overflow. Therefore, overflow detection is performed by searching the 33^{rd} and all higher bits for any deviation from the sign represented by the 32^{nd} bit. Again, the commands on the left apply to FIG. 1A, and those on the right apply to FIG. 1B.

if (Z[63:32] !={32{Z[31]}}) if (Z[64:32] !={33{Z[31]}})

OVF=1; OVF=1;

else else

OVF=0; OVF=0;

The overflow detection circuit utilizes a comparator as wide as the difference of the width of the intermediate result vectors Y or Z and the reduced-width result vectors Y1 or Z1. In our example, a 32 bit wide comparator is required for signed or unsigned multiplication without accumulation (FIG. 1A). A 33 bit wide comparator is required for signed or unsigned multiplication with accumulation (FIG. 1B). The delay of the relatively large comparator directly adds to the timing critical path of the system.

From FIGS. 1A and 1B, it should be apparent that overflow detection is based on the highest-order bits of the intermediate result Y and Z. The higher-order bits may be the last to be produced by the multiplier (and accumulator). Thus, the timing of the system is even more affected by the overflow detection circuitry.

### SUMMARY OF THE INVENTION

To address these and other concerns, the inventor proposes a math device having a multiplier and an overflow detector. The multiplier multiplies an n-bit input with an m-bit input and produces a reduced width output without producing an intervening data file having a width greater than or equal to n+m. The overflow detector determines if the reduced width output eliminates non-redundant bits.

The multiplier may produce the reduced width output without producing an intervening data file having a width greater than or equal to 0.8*(n+m), more specifically, without producing an intervening data file having a width greater than or equal to 0.6*(n+m) and still more specifically without producing an intervening data file having a width greater than or equal to (0.5*(n+m))+4.

An accumulator may be included to add a p-bit input to the reduced width output of the multiplier so as to produce a p-bit accumulation result. In this case, if m=n=p, the overflow detector determines if the p-bit accumulation result eliminates non-redundant bits.

According to a second aspect, the math device has a multiplier and an overflow detector. The multiplier multiplies an m-bit input with an n-bit input and produces an output. The overflow detector determines when the product of the m-bit input and the n-bit input would exceed o-bits, where o<(m+n). The overflow detector has a first overflow unit provided in parallel to the multiplier, and a second overflow unit provided in series with the multiplier.

According to the second aspect, the following may apply: m=n=o.

CLZ(A) represents the number of leading zeros in the m-bit input, and CLZ(B) represents the number of leading zeros in the n-bit input. With the second aspect, if the m-bit input and the n-bit input are unsigned, then the first overflow unit may determine fatal overflow if CLZ(A)+CLZ(B)≦o−2. If the math device includes an accumulator to add a p-bit input to the output of the multiplier, and the m-bit input and the n-bit input are unsigned, then the first overflow unit may determine fatal overflow if CLZ(A)+CLZ(B)≦o−2. In this case, it is possible that m=n=o=p.

CLS(A) represents the number of leading signs in the m-bit input, and CLS(B) represents the number of leading signs in the n-bit input. With the second aspect, if the m-bit input and the n-bit input are signed, then the first overflow unit may determine fatal overflow if CLS(A)+CLS(B)≦o−1. If the math device includes an accumulator to add a p-bit input to the output of the multiplier, and the m-bit input and the n-bit input are signed, then the first overflow unit may determine fatal overflow if CLS(A)+CLS(B)≦o−2. In this case too, it is possible that m=n=o=p.

According to the second aspect, an OR gate may receive the results from the first and second overflow units and produce an overflow signal when at least one of the overflow units determines that the non-truncate result would exceed o bits. In this case, a saturation unit outputs a saturated result if the OR gate produces the overflow signal and otherwise outputs the product of the multiplier.

According to the second aspect, the first overflow unit may be able to detect fatal overflow based on the widths of the m-bit input and the n-bit input without examining the output of the multiplier.

According to a third aspect, the inventor proposes a math device having a multiplication unit and an overflow detector. The multiplication unit multiplies an m-bit input and an n-bit input and produces an output. The overflow detector determines if the output has an actual width less than or equal to a predetermined width, which is less than m+n bits. The overflow detector has a comparator provided on a critical timing path, the comparator requiring only a review of 4 bits.

According to the third aspect, the predetermined width may be o-bits and the relationship m=n=o may apply. The comparator may compare bit o+1 with logical “0”, or may compare bits o+2 and o+1 with logical “0”, or may compare bits o+2 and o+1 with bit o, or may compare bits o+3, o+2 and o+1 with bit o.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1A is a schematic view of a multiplier of the related art, which employs saturation;

FIG. 1B is a schematic view of a multiplier with accumulation of the related art, which employs saturation; and

FIG. 2 is a schematic view of one possible application for an overflow detection system according to the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

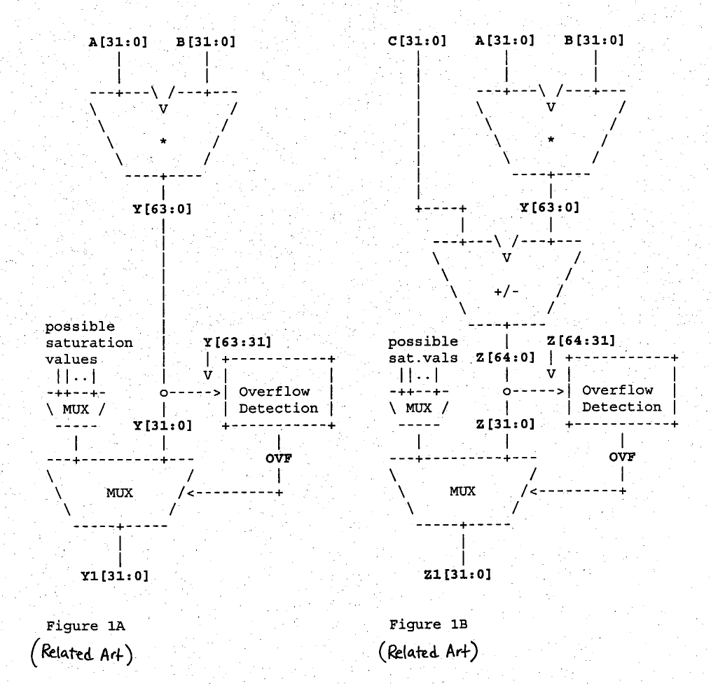

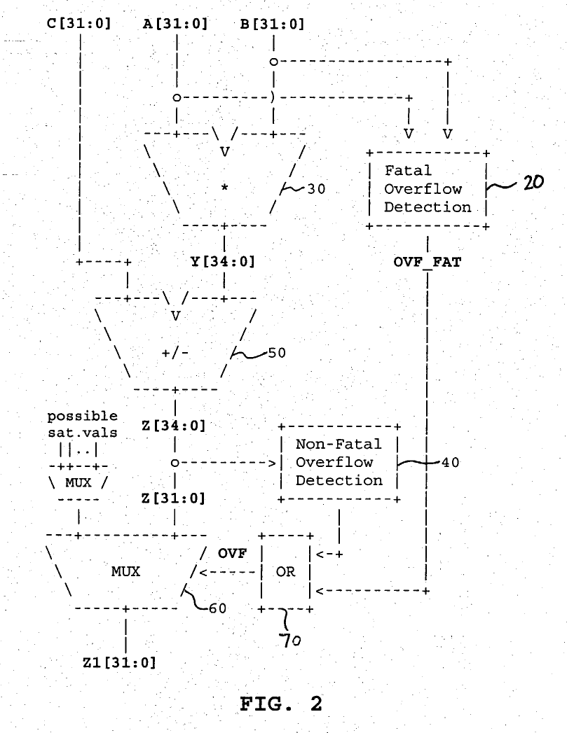

FIG. 2 is a schematic view of one possible application for an overflow detection system according to the invention. Comparing FIG. 2 with FIGS. 1A and 1B, it should be apparent that overflow detection is divided into two parts. A fatal overflow detection circuit 20 is provided in parallel with the multiplier 30 or multiplier 30 and accumulator 50. Fatal overflow detection is based on a review of the inputs A and B. Then, after multiplication (and accumulation), a non-fatal overflow detection circuit 40 examines a portion of the result to determine if there is overflow. The fatal overflow detection circuit 20 estimates the width of the resulting vector Y or vector Z based on the width of inputs A and B. Although this estimation is not completely accurate, the fatal overflow detection circuit 20 assumes that if both of the inputs are very wide, then the product of the inputs will be very wide, too wide to fit into an output vector having the same width as the input vectors. In this manner, the non-fatal overflow detection circuit 40 only needs to focus on the results that fall in a gray area of fatal-overflow detection uncertainty, where they may or may not fit in a reduced-width output vector. While fatal overflow detection identifies “very big overflow” scenarios, non-fatal overflow detection identifies the remaining “not so big overflow” scenarios.

Because the fatal overflow detection circuit 20 only requires the inputs A and B for operation, fatal overflow detection can be done in parallel to the actual multiplication (and accumulation). Fatal overflow detection is therefore removed from the critical timing path. All that remains to be done on the critical timing path is the less complex non-fatal overflow detection.

Before the fatal overflow detection block in FIG. 2 is reviewed in detail, it will be shown that it is possible to estimate the multiplication result based on the width of the inputs A and B. The estimation will not be exact, but it will suffice to identify “very big overflow” scenarios.

We define the actual width of a binary number as the width of a vector that can hold this binary number without any redundant high-order bits. For unsigned numbers this means that there are no leading zeros. For signed numbers this minimum width vector holds only one non-redundant sign bits. For example, the actual width of the unsigned value ‘6’ is 3 bit (3′b 110). Any vector wider than 3 bit can hold the unsigned value ‘6’, but it would hold redundant ‘0’ in the high-order bit positions. A vector smaller than 3 bit wide cannot hold the unsigned value ‘6’. On the other hand, the actual width of the signed value ‘+6’ is 4 bit (4′b 0110).

The actual width u of an unsigned number A is defined as following:

Actual width of unsigned A>0: u=truncate(log₂(A))+1 (1)

Actual width of unsigned A=0: u=0 (2)

The actual width u of an signed number A is defined as following:

Actual width of signed A>0: u=truncate(log₂(A))+2 (3)

Actual width of signed A<−1: u=truncate(log₂(1−A))+2 (4)

Actual width of signed A=0: u=1 (5)

Actual width of signed A=−1: u=1 (6)

The actual width u of any given unsigned number A can be determined by subtracting the count of redundant leading zeros from the real width of the vector holding A. For a n-bit vector A this yields:

Actual width of unsigned number A: u=n−CLZ(A) (7)

The actual width u of any given signed number A can be determined by subtracting the count of leading sign bits from the real width of the vector holding A, incremented by one. The increment by one is necessary to account for the one sign bit, which is not redundant and must be included in the actual width of a signed number. For a n-bit vector A this yields:

Actual width of signed number A: u=(n+1)−CLS(A) (8)

The count-leading-zeros algorithm (CLZ) used to determine the actual width of unsigned numbers can be easily implemented in a digital circuit. The count-leading-signs algorithm (CLS) used to determine the actual width of signed numbers can be replaced by a CLZ algorithm, if the signed argument to the CLS problem is inverted entirely in case of negative signed numbers. Negative numbers are recognized by the ‘1’ in the most significant bit position. This way leading negative sign bits are converted to leading zeros. For positive signed numbers no conversion is necessary in order to apply the CLZ algorithms, because leading positive sign bits are equivalent to leading zeros.

It is assumed that A and B are unsigned vectors having respective actual widths of u and v. The following shows that the multiplication result (A*B) cannot be bigger than the upper limit (2^{u+v}−1), and cannot be smaller than the lower limit (2^{u+v-2}).

Largest A with actual width u: A≦2^{u}−1 (9)

Largest B with actual width v: B≦2^{v}−1 (10)

Smallest A with actual width u: A≧2^{u-1} (11)

Smallest B with actual width v: B≧2^{v-1} (12)

Maximum multiplication result:

A*B≦(2^{u}−1)*(2^{v}−1) (13)

A*B≦2^{u+v}−2^{u}+2^{v}+1 (14)

A*B≦2^{u+v}−1 (15)

Minimum multiplication result:

A*B≧(2^{u-1})*(2^{v-1}) (16)

A*B≧2^{u+v-2} (17)

During unsigned multiplication fatal overflow occurs, if the smallest possible multiplication result is still too big to fit in the n-bit wide reduced-width output vector.

Fatal overflow occurs, if:

2^{u+v-2}≧2ⁿ (18)

u+v≧n+2 (19)

This is equivalent to: CLZ(A)+CLZ(B)≦n−2 (20)

During unsigned multiplication with accumulation fatal overflow occurs, if the smallest possible multiplication result, after being accumulated to the third input C, is still too big to fit in the n-bit wide reduced-width output vector, no matter what the value of the n-bit wide input C is.

Fatal overflow occurs, if:

2^{u+v-2}≧2ⁿ (21)

u+v≧n+2 (22)

This is equivalent to: CLZ(A)+CLZ(B)≦n−2 (23)

It is now assumed that A and B are signed vectors having respective actual widths of u and v. The following shows that the multiplication result (A*B) cannot be bigger in magnitude than the upper limit (2^{u+v-2}), and cannot be smaller in magnitude than the lower limit (2^{u+v-4}).

Largest positive A with actual width u: A≦2^{u-1}−1 (24)

Largest positive B with actual width v: B≦2^{v-1}−1 (25)

Largest negative A with actual width u: A≧−(2^{u-1}) (26)

Largest negative B with actual width v: B≧−(2^{v-1}) (27)

Smallest positive A with actual width u: A≧2^{u-2} (28)

Smallest positive B with actual width v: B≧2^{v-2} (29)

Smallest negative A with actual width u: A≦−(2^{u-2}+1) (30)

Smallest negative B with actual width v: B≦−(2^{v-2}+1) (31)

Maximum positive mult. result:

A*B≦−(2^{u-1})*−(2^{v-1}) (32)

A*B≦2^{u+v-2} (33)

Maximum negative mult. result:

A*B≧−(2^{u-1})*(2^{v-1}−1) (34)

A*B≧−(2^{u+v-2})+2^{u-1} (35)

A*B≧−(2^{u+v-2}−1) (36)

Minimum positive mult. result:

A*B≧(2^{u-2})*(2^{v-2}) (37)

A*B≧2^{u+v-4} (38)

Minimum negative mult. result:

A*B≦−(2^{u-2}+1)*(2^{v-2}) (39)

A*B≦−(2^{u+v-4})−2^{v-2} (40)

A*B≦−(2^{u+v-4}) (41)

During signed multiplication fatal overflow occurs, if the smallest possible multiplication result is still too big to fit in the n-bit wide reduced-width output vector.

Fatal overflow occurs, if:

2^{u+v-4}≧2ⁿ⁻¹ (42)

u+v≧n+3 (43)

This is equivalent to: CLS(A)+CLS(B)≦n−1 (44)

During signed multiplication with accumulation fatal overflow occurs, if the smallest possible multiplication result, after being accumulated to the third input C, is still too big to fit in the n-bit wide reduced-width output vector, no matter what the value of the n-bit wide input C is.

Fatal overflow occurs, if:

2^{u+V-4}≧2ⁿ (45)

u+v≧n+4 (46)

This is equivalent to: CLS(A)+CLS(B)≦n−2 (47)

The results from above are summarized in the following table. It shows the occurrence of fatal overflow, if two inputs A and B are multiplied, possibly accumulated to a third n-bit wide input C, and reduced to an n-bit wide output vector.

| | unsigned operation | signed operation |
|---|---|---|
| multiplication | CLZ(A) + CLZ(B) ≦ n − 2 | CLS(A) + CLS(B) ≦ n − 1 |
| multiplication | CLZ(A) + CLZ(B) ≦ n − 2 | CLS(A) + CLS(B) ≦ n − 2 |
| with | | |
| accumulation | | |

The following table shows the occurrence of fatal overflow for the specific example of a 32 bit wide reduced-width output vector.

| | unsigned operation | signed operation |
|---|---|---|
| multiplication | CLZ(A) + CLZ(B) ≦ 30 | CLS(A) + CLS(B) ≦ 31 |
| multiplication | CLZ(A) + CLZ(B) ≦ 30 | CLS(A) + CLS(B) ≦ 30 |
| with accumulation | | |

The operation of the fatal overflow detection circuit 20 will now be reviewed. First, the number of leading zeros or leading sign bits of the two input vectors A and B is determined. The sum of the two is then compared against a certain limit, which is shown in the tables above. This limit depends on the operation at hand, and on the width of the reduced-width output vector. If this limit cannot be reached or exceeded, fatal overflow is signaled.

In summary, fatal overflow is accurately predicted by examining only the actual widths of the two input vectors A and B. Fatal overflow detection is performed in parallel to multiplication (and accumulation) and produces a fatal overflow result no later than the multiplication (and accumulation) result.

Turning now to non-fatal overflow, it can be seen from FIG. 2 that non-fatal overflow must be detected on the critical timing path by examining the multiplication (and accumulation) result. However, since the fatal overflow detection circuit 20 finds all “very big overflow” scenarios, only the “small overflow” scenarios remain. These remaining cases can be identified by examining only a small number of result bits.

For unsigned multiplication, the largest possible input vectors A and B that do not trigger fatal overflow have a combined actual width of (n+1). Such inputs can produce a maximum multiplication result that is (n+1) bit wide. During non-fatal overflow detection it is therefore sufficient to check, whether bit (n+1) contains a redundant zero or not.

Largest non-fatal inputs A and B: u+v=n+1 (48)

Maximum non-fatal mult. result:

A*B≦2^{u+v}−1 (49)

A*B≦2ⁿ⁺¹−1 (50)

For unsigned multiplication with accumulation, the largest possible input vectors A and B that do not trigger fatal overflow have a combined actual width of (n+1). Such inputs can produce a maximum multiplication and accumulation result that is (n+2) bit wide. During non-fatal overflow detection it is therefore sufficient to check, whether bits (n+1) and (n+2) contain redundant zeros or not.

Largest non-fatal inputs A and B: u+v=n+1 (51)

Maximum non-fatal accum. result:

C+A*B≦(2ⁿ−1)+(2^{u+v}−1) (52)

C+A*B≦2ⁿ⁺¹+2ⁿ−2 (53)

For signed multiplication, the largest possible input vectors A and B that do not trigger fatal overflow have a combined actual width of (n+2). Such inputs can produce a maximum multiplication result that is (n+2) bit wide. During non-fatal overflow detection it is therefore sufficient to check, whether bits (n+1) and (n+2) contain redundant copies of the sign bit n or not.

Largest non-fatal inputs A and B: u+v=n+2 (54)

Maximum pos. non-fatal mult. result:

A*B≦2^{u+v-2} (55)

A*B≦2ⁿ (56)

Maximum neg. non-fatal mult. result:

A*B≧−(2^{u+v-2}−1) (57)

A*B≧−(2ⁿ−1) (58)

For signed multiplication with accumulation, the largest possible input vectors A and B that do not trigger fatal overflow have a combined actual width of (n+3). Such inputs can produce a maximum multiplication and accumulation result that is (n+3) bit wide. During non-fatal overflow detection it is therefore sufficient to check, whether bits (n+1), (n+2) and (n+3) contain redundant copies of the sign bit n or not.

Largest non-fatal inputs A and B: u+v=n+3 (59)

Maximum pos. non-fatal accum. result:

C+A*B≦(2ⁿ⁻¹−1)+(2^{u+v-2}) (60)

C+A*B≦2ⁿ⁺¹+2ⁿ⁻¹−1 (61)

Maximum neg. non-fatal accum. result:

C+A*B≧−(2ⁿ⁻¹)+−(2^{u+v-2}−1) (62)

C+A*B≧−(2ⁿ⁺¹+2ⁿ⁻¹−1) (63)

The results from above are summarized in the following table. It shows which portion of the multiplication (and accumulation) result needs to be examined during non-fatal overflow detection, when the reduced-width output vector is n-bit wide.

| | unsigned operation | signed operation |
|---|---|---|
| multiplication | Y[n + 1] == 0 | Y[(n + 2):(n + 1)] == Y[n] |
| multiplication | Z[(n + 2):(n + 1)] == 0 | Z[(n + 3):(n + 1)] == Z[n] |
| with | | |
| accumulation | | |

The following table shows the portion of the multiplication (and accumulation) result that needs to be examined during non-fatal overflow detection for the specific example of a 32 bit wide reduced-width output vector.

| | unsigned operation | signed operation |
|---|---|---|
| multiplication | Y[32] == 0 | Y[33:32] == Y[31] |
| multiplication | Z[33:32] == 0 | Z[34:32] == Z[31] |
| with | | |
| accumulation | | |

The non-fatal overflow detection circuit 40 of FIG. 2 contains a comparator that is 3 bit wide or smaller. For unsigned operation, one or two bits of the multiplication (and accumulation) result are compared against zero. For signed operation two or three bits of the multiplication (and accumulation) result are compared against the sign bit of the reduced-width intermediate result. The exact comparison, as shown in the tables above, depends on the operation at hand, but is independent of the width of the reduced-width output vector or the input vectors. If the comparison yields any mismatch, non-fatal overflow is signaled.

Neither the fatal overflow detection block 20, nor the non-fatal overflow detection block 40 can detect all overflow cases alone. The fatal overflow detection circuit 20 misses some “small overflow” scenarios due to its conservative approach to estimate the multiplication result from the widths of the inputs A and B. On the other hand, the non-fatal overflow detection circuit 40 does not recognize numerous “very big overflow” scenarios, because it only considers a limited number og high-order bits from the multiplication (and accumulation) result. However, no overflow will escape detection by both detection blocks. Therefore, the output of the fatal overflow detection circuit 20 is OR-ed with the output of non-fatal overflow detection circuit 40. Block 70 is an OR gate, not an XOR (exclusive OR) gate. If one or both of the circuits 20 and 40 produce an output which is high, the OR block 70 assumes there is overflow.

The result of the OR block 70 gate is fed to a multiplexer which affects saturation in a manner similar to that of FIGS. 1A and 1B. If there is an overflow situation, the intermediate result vector Y or Z is replaced with a pre-determined saturation value, which is the maximum or minimum number that can be represented in the reduced-width output vector.

The system shown in FIG. 2 has many potential advantages over the system shown in FIGS. 1A and 1B, the advantages depending on the exact implementation. Even though non-fatal overflow detection is still performed on the timing critical path, non-fatal overflow adds much less delay to the path than was added by the overflow detection scheme shown in FIGS. 1A and 1B. The non-fatal overflow circuit 40 may be implemented with a no more than 3 bit wide comparator. Thus, only a small comparator and the OR block 70 are located on the timing critical path. The width of the comparator is independent of the input vector width. The delay associated with the 3 bit comparator and the OR-block 70 is notably shorter than that of an n-bit comparator required for the system shown in FIGS. 1A and 1B. The width of the comparator for the system shown in FIGS. 1A and 1B. depends on the width of the input vector.

Another speed advantage is associated with the position of the bits considered in the non-fatal overflow detection circuit 40. Specifically, if the reduced-width output vector is 32 bit wide, it is sufficient for the non-fatal overflow detection circuit to include bits [34:31] in the comparison process. For the same 32 bit wide output vector, the system shown in FIGS. 1A and 1B includes bits [64:32] in the comparison. Especially the higher-order bits close to bit [64] may take significantly longer to develop in the preceding logic block. The overflow detection circuits of FIGS. 1A and 1B can only start operation when all high-order bits are available, whereas the non-fatal overflow detection block 40 of FIG. 2 can potentially start operation much earlier.

It is also important to note that the majority of the high-order bits are not used for anything. They are neither used for overflow detection nor during saturation. This is because fatal overflow is based on the inputs, not on any multiplication (and accumulation) result, and non-fatal overflow detection does not rely on the higher-order bits. For example, if the reduced-width output vector is 32 bit wide, then bits [64:35] of the intermediate result vector Y or Z are not required. Therefore, it is not necessary to develop these high-order bits. The size of the preceding logic, specifically the multiplier 30 and the accumulator 50 can be reduced substantially. This, in turn, reduces power consumption.

The system shown in FIG. 2 applies only to one specific implementation of the invention. For example, FIG. 2 shows the input vectors A, B and C and the output vector Z1 as being 32 bit wide. The invention is not limited to 32 bit width. Any bit width can be used. The bit widths of the input and output vectors do not need to be identical neither. FIG. 2 further shows that accumulation is done after multiplication. Accumulation is optional. Further, FIG. 2 shows that the output of the multiplier 30 and the accumulator 50 are both truncated to a 35 bit width. There are some applications when it will be desired to keep the full-width result and still perform overflow detection. The non-fatal overflow detection circuit is described as requiring only a 3 bit comparator. However, larger comparators can be used as well. The saturation multiplexer 60 is yet another example of the unnecessary specificity. Some applications would use the result of overflow detection for a purpose other than saturation. The above description separately describes the use of signed and unsigned inputs. However, mixed cases are also possible, in which both signed and unsigned inputs. Additionally, FIG. 2 has been described with regard to integer multiplication and integer multiplication with accumulation. However, non-integer number could also be used.

The invention has been described in detail with particular reference to preferred embodiment thereof and examples, but it will be understood that variations and modifications can be effected within the spirit and scope of the invention.

What is claimed is:

1. A math device comprising:
a multiplier to multiply an n-bit input with an m-bit input and produce a reduced width output without producing an intervening data file having a width greater than or equal to n+m; and
an overflow detector to determine if the reduced width output eliminates non-redundant bits.

2. A math device according to claim 1, wherein the multiplier produces the reduced width output without producing an intervening data file having a width greater than or equal to 0.8 * (n+m).

3. A math device according to claim 1, wherein the multiplier produces the reduced width output without producing an intervening data file having a width greater than or equal to 0.6* (n+m)

4. A math device according to claim 1, wherein the multiplier produces the reduced width output without producing an intervening data file having a width greater than or equal to (0.5* (n+m))+4.

5. A math device according to claim 1, wherein
the device further comprises an accumulator to add a p-bit input to the reduced width output of the multiplier so as to produce an accumulation result having a width less than m+n, and
the overflow detector determines if the accumulation result eliminates non-redundant bits.

6. A math device, comprising:
a multiplier to multiply an m-bit input with an n-bit input and produce an output; and
an overflow detector to determine when the product of the m-bit input and the n-bit input would exceed o-bits, where o<(m+n), the overflow detector comprising:
a first overflow unit provided in parallel to the multiplier, and
a second overflow unit provided in series with the multiplier.

7. A math device according to claim 6 wherein m=n=o.

8. A math device according to claim 6 wherein
CLZ(A) represents the number of leading zeros in the m-bit input,
CLZ(B) represents the number of leading zeros in the n-bit input,
the m-bit input and the n-bit input are unsigned, and
the first overflow unit determines fatal overflow if CLZ(A)+CLZ(B)≦o−2.

9. A math device according to claim 6 wherein
the math device further comprises an accumulator to add a p-bit input to the output of the multiplier,
CLZ(A) represents the number of leading zeros in the m-bit input,
CLZ(B) represents the number of leading zeros in the n-bit input,
the m-bit input and the n-bit input are unsigned, and
the first overflow unit determines fatal overflow if CLZ(A)+CLZ(B)≦o−2.

10. A math device according to claim 9 wherein m=n=o=p.

11. A math device according to claim 6 wherein
CLS(A) represents the number of leading signs in the m-bit input,
CLS(B) represents the number of leading signs in the n-bit input,
the m-bit input and the n-bit input are signed, and
the first overflow unit determines fatal overflow if CLS(A)+CLS(B)≦o−1.

12. A math device according to claim 6 wherein
the math device further comprises an accumulator to add a p-bit input to the output of the multiplier,
CLS(A) represents the number of leading signs in the m-bit input,
CLS(B) represents the number of leading signs in the n-bit input,
the m-bit input and the n-bit input are signed, and
the first overflow unit determines fatal overflow if CLS(A)+CLS(B)≦o−2.

13. A math device according to claim 12 wherein m=n=o=p.

14. A math device according to claim 6, further comprising an OR gate to receive results from the first and second overflow units and produce an overflow signal when at least one of the overflow units determines that the product of the m-bit input and the n-bit input would exceed o-bits.

15. A math device according to claim 14, further comprising a saturation unit to output a saturated result if the OR gate produces the overflow signal and otherwise output the product of the multiplier.

16. A math device according to claim 6, wherein the first overflow unit detects fatal overflow based on the widths of the m-bit input and the n-bit input without examining the output of the multiplier.

17. A math device comprising:
a multiplication unit to multiply an m-bit input and an n-bit input and produce an output;
an overflow detector to determine if the output has an actual width less than or equal to a predetermined width, the predetermined width being less than m+n bits, the overflow detector comprising a comparator provided on a critical timing path, the comparator requiring only a review of 4 or fewer bits.

18. A math device according to claim 17 wherein
the predetermined width is o-bits,
m=n=o, and
the comparator compares bit o+1 with logical “0”.

19. A math device according to claim 18 wherein
the predetermined width is o-bits,
m=n=o, and
the comparator compares bits o+2 and o+1 with logical “0”.

20. A math device according to claim 17 wherein
the predetermined width is o-bits,
m=n=o, and
the comparator compares bits o+2 and o+1 with bit o.

21. A math device according to claim 20 wherein
the predetermined width is o-bits,
m=n=o, and
the comparator compares bits o+3, o+2 and o+1 with bit o.

22. A math device according to claim 17 wherein the comparator compares more than 4 bits, but has logic requiring only a review of 4 or fewer bits to determine if the output has an actual width less than or equal to the predetermined width.
